(19) United States
(12) Patent Application Publication
(10) Pub. No.: US 2026/0010226 A1
(43) Pub. Date: Jan. 8, 2026

(54) TECHNIQUES FOR CALIBRATING LOCALIZATION PARAMETERS BASED ON PHYSICALLY-IDENTIFIABLE LANDMARKS, AND SYSTEMS, DEVICES AND METHODS OF USING SUCH TECHNIQUES

(71) Applicant: Meta Platforms Technologies, LLC, Menlo Park, CA (US)

(72) Inventors: Sean Garrett Kelly, Fall City, WA (US); Ata Dogan, Seattle, WA (US)

(21) Appl. No.: 19/260,139

(22) Filed: Jul. 3, 2025

Related U.S. Application Data
(60) Provisional application No. 63/667,605, filed on Jul. 3, 2024.

(51) Int. Cl. G06F 3/01; G02B 27/01; G06F 3/16; G06T 19/00

(52) U.S. Cl. CPC G06F 3/012; G02B 27/017; G06F 3/167; G06T 19/003; G06T 19/006

(57) ABSTRACT

A method of interacting with extended-reality glasses is provided. The method includes determining, based on the sensor data, that a landmark-based-localization condition is satisfied. The method further includes, in accordance with determining that the landmark-based-localization condition is satisfied, obtaining data about a physically-identifiable feature of a physical landmark detectable from the localized physical area. And the method includes, based on (i) the data about the physically-identifiable feature of the physical landmark, and (ii) other data indicating a time when the data about the physically-identifiable feature of the physical landmark was obtained, determining an orientation and/or and a position of the head-wearable device within the localized physical area.

### RELATED APPLICATIONS

This application claims priority to U.S. Prov. App. No. 63/667,605, filed on Jul. 3, 2024, and entitled “Techniques for Calibrating Localization Parameters Based on Physically-Identifiable Landmarks, and Systems, Devices and Methods of Using Such Techniques,” which is hereby incorporated by reference in its entirety.

### TECHNICAL FIELD

This relates generally to navigating with digital technology, and specifically to calibrating localization parameters based on physically-identifiable landmarks.

### SUMMARY

The inventors of the present application uniquely identified certain problems with, and solutions to, existing technological means for localizing a user interaction with electronic devices based on particular information identified using imaging data, where other techniques such as global positions system (GPS) based navigation lack precision for determining positions and/or orientations of users within localized areas, as well as when alternative and/or additional sensing capabilities that can improve such localization for small areas, such as inertial measurement units (IMUs) and/or compasses, are subject to drift and other issues that may degrade the accuracy of such techniques.

To solve the problems discussed above the inventors of the present application have uniquely identified the solutions discussed below.

One example method at a head-wearable device (e.g., augmented-reality and/or mixed-reality headsets) is described herein. The method includes obtaining, at a head-wearable device, sensor data about a localized physical area. The method further includes determining, based on the sensor data, that a landmark-based-localization condition is satisfied, obtaining data about a physically-identifiable feature of a physical landmark detectable from the localized physical area. The method includes determining, based on the sensor data, that a landmark-based-localization condition is satisfied. The method includes, in accordance with determining that the landmark-based-localization condition is satisfied, obtaining data about a physically-identifiable feature of a physical landmark detectable from the localized physical area. And the method includes, based on (i) the data about the physically-identifiable feature of the physical landmark, and (ii) other data indicating a time when the data about the physically-identifiable feature of the physical landmark was obtained, determining an orientation and/or and a position of the head-wearable device within the localized physical area.

Instructions that cause performance of the methods and operations described herein can be stored on a non-transitory computer readable storage medium. The non-transitory computer-readable storage medium can be included on a single device or across multiple devices of a system. A non-exhaustive of list of devices that can either alone or in combination (i.e., a system) perform the method and operations described herein include extended-reality headset (e.g., a mixed-reality (MR) headset or an augmented-reality (AR) headset as two examples), a wrist-wearable device, an intermediary processing device, a smart textile-based garment, etc.). For instance, the instructions can be stored on an AR headset or can be stored on a combination of an AR headset and an associated input device (e.g., a wrist-wearable device) such that instructions for causing detection of input operations can be performed at the input device and instructions for causing changes to a displayed user interface in response to those input operations can be performed at the AR headset. The devices and systems described herein can be configured to be used in conjunction with methods and operations for providing an extended-reality experience. The methods and operations for providing an extended-reality experience can be stored on a non-transitory computer-readable storage medium.

The devices and/or systems described herein can be configured to include instructions that cause performance of methods and operations associated with the presentation and/or interaction with an extended-reality. These methods and operations can be stored on a non-transitory computer-readable storage medium, which can be included on the device. It is also noted the devices and systems described herein can be part of a larger overarching system that include multiple devices. A non-exhaustive of list of devices that can either alone or in combination (i.e., a system) include instructions that cause performance of methods and operations associated with the presentation and/or interaction with an extended-reality include: an extended-reality headset (e.g., a mixed-reality (MR) headset or an augmented-reality (AR) headset as two examples), a wrist-wearable device, an intermediary processing device, a smart textile-based garment, etc. For example, when a XR headset is described as, it is understood that the XR headset can be in communication with one or more other devices (e.g., a wrist-wearable device, a server, intermediary processing device, etc.) which in together can include instructions for performing methods and operations associated with the presentation and/or interaction with an extended-reality (i.e., the XR headset would be part of a system that includes one or more additional device). Multiple combinations with different related devices are envisioned, but not recited for brevity.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A to 1C illustrate an example sequence of a user's interaction with an augmented-reality device while the user is interacting with augmented-reality content for causing localized user interactions using physical-landmark-based localization techniques, in accordance with some embodiments.

FIGS. 2A, 2B, and 2C-1, and 2C-2 illustrate example MR and AR systems, in accordance with some embodiments.

FIG. 3 illustrates a flow chart describing a method of calibrating localization parameters based on physically-identifiable landmarks, in accordance with some embodiments.

In accordance with customary practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

Embodiments of this disclosure can include or be implemented in conjunction with distinct types or embodiments of extended-realities (XR) such as mixed-reality (MR) and augmented-reality (AR) systems. Mixed-realities and augmented-realities, as described herein, are any superimposed functionality and or sensory-detectable presentation provided by a mixed-reality and augmented-reality systems within a user's physical surroundings. Such mixed-realities can include and/or represent virtual realities and virtual realities in which at least some aspects of the surrounding environment are reconstructed within the virtual environment (e.g., displaying virtual reconstructions of physical objects in a physical environment to avoid the user colliding with the physical objects in surrounding physical environment). In the case of mixed-realities, the surrounding environment that is presented is captured via one or more sensors configured to capture the surrounding environment (e.g., a camera). While the wearer of a mixed-reality headset may see the surrounding environment in full detail, they are seeing a reconstruction of the environment reproduced via the one or more sensors (i.e., the physical objects are not directly viewed by the user). A MR headset can also forgo displaying reconstructions of objects in the physical environment, thereby providing a user with an entirely virtual reality (VR) experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es). Throughout this application, the term extended realities (XR) is a catchall term to cover both augmented realities and mixed realities. In addition, head-wearable device is catchall term that covers extended-reality headsets such as augmented-reality headsets and mixed-reality headsets.

In one example AR or MR system, a user can perform a swiping in-air hand gesture to cause a song to be skipped by a song-providing API providing playback at, for example, a home speaker. As alluded to above a MR environment, as described herein, can include, but is not limited to, VR environments can, include non-immersive, semi-immersive, and fully immersive VR environments. As also alluded to above, AR environments can include marker-based augmented-reality environments, markerless augmented-reality environments, location-based augmented-reality environments, and projection-based augmented-reality environments. The above descriptions are not exhaustive and any other environment that allows for intentional environmental lighting to pass through to the user would fall within the scope of augmented-reality and any other environment that does not allow for intentional environmental lighting to pass through to the user would fall within the scope of a mixed-reality.

AR and MR content can include completely generated content or generated content combined with captured (e.g., real-world) content. The AR and MR content can include video, audio, haptic events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMU)s of a wrist-wearable device, and/or one or more sensors included in a smart textile wearable device) and/or detected via image data captured by an imaging device of a wearable device (e.g., a camera of a head-wearable device, an external tracking camera setup in the surrounding environment)) or a combination of the user's hands. In-air can mean that the user hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single or double finger tap on a table, on a user's hand or another finger, on the user's leg, a couch, a steering wheel, etc.). The different hand gestures disclosed herein can be detected using image data and/or sensor data (e.g., neuromuscular signals sensed by one or more biopotential sensors (e.g., EMG sensors) or other types of data from other sensors, such as proximity sensors, time-of-flight (ToF) sensors, sensors of an inertial measurement unit (IMU), capacitive sensors, strain sensors, etc.) detected by a wearable device worn by the user and/or other electronic devices in the user's possession (e.g., smartphones, laptops, imaging devices, intermediary devices, and/or other devices described herein).

The devices include systems, wrist-wearable devices, headset devices, and smart textile-based garments. Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, an HIPD, a smart textile-based garment, or other computer system). There are distinct types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., virtual-reality animations, such as three-dimensional modeling); (iv) a field-programmable gate array (FPGA) that can be programmed and reconfigured after manufacturing and/or customized to perform specific tasks, such as signal processing, cryptography, and machine learning; (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or DSPs. As described herein, a graphics module is a component or software module that is designed to handle graphical operations and/or processes, and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include: (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) POGO pins, which may be small, spring-loaded pins configured to provide a charging interface; (v) wireless charging interfaces; (vi) global-position system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a SLAM camera(s)); (ii) biopotential-signal sensors; (iii) inertial measurement unit (e.g., IMUs) for detecting, for example, angular rate, force, magnetic field, and/or changes in acceleration; (iv) heart rate sensors for measuring a user's heart rate; (v) SpO2 sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors), and (viii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include: (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) electromyography (EMG) sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications, (x) camera applications, (xi) web-based applications; (xii) health applications; (xiii) AR and MR applications, and/or any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., application programming interfaces (APIs) and protocols such as HTTP and TCP/IP).

As described herein, a graphics module is a component or software module that is designed to handle graphical operations and/or processes, and can include a hardware module and/or a software module.

As described herein, non-transitory computer-readable storage media are physical devices or storage medium that can be used to store electronic data in a non-transitory form (e.g., such that the data is stored permanently until it is intentionally deleted or modified).

### Example Interaction Sequence

Having thus provided an overview and definitions used for components and concepts relevant to the disclosure, an example sequence illustrating aspects of an example system for using the techniques and systems disclosed herein will now be described.

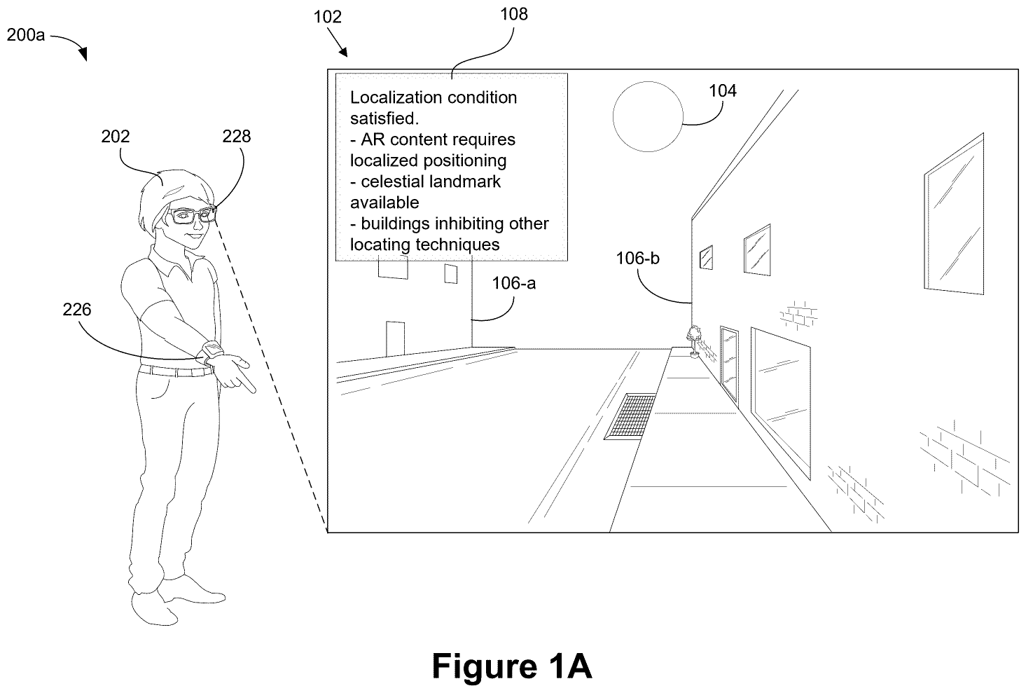

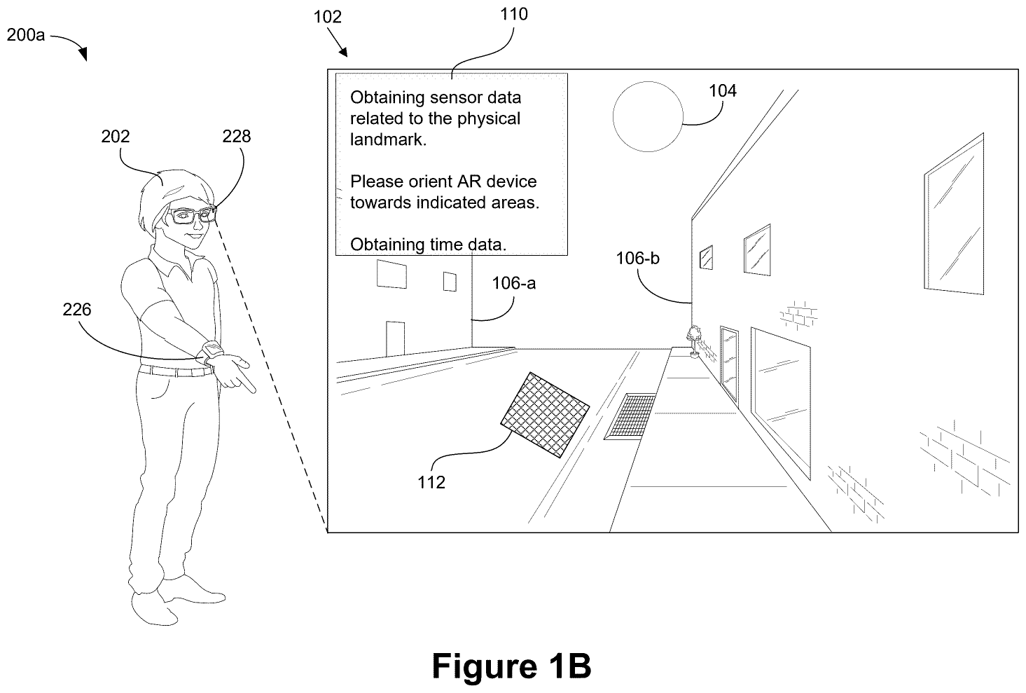

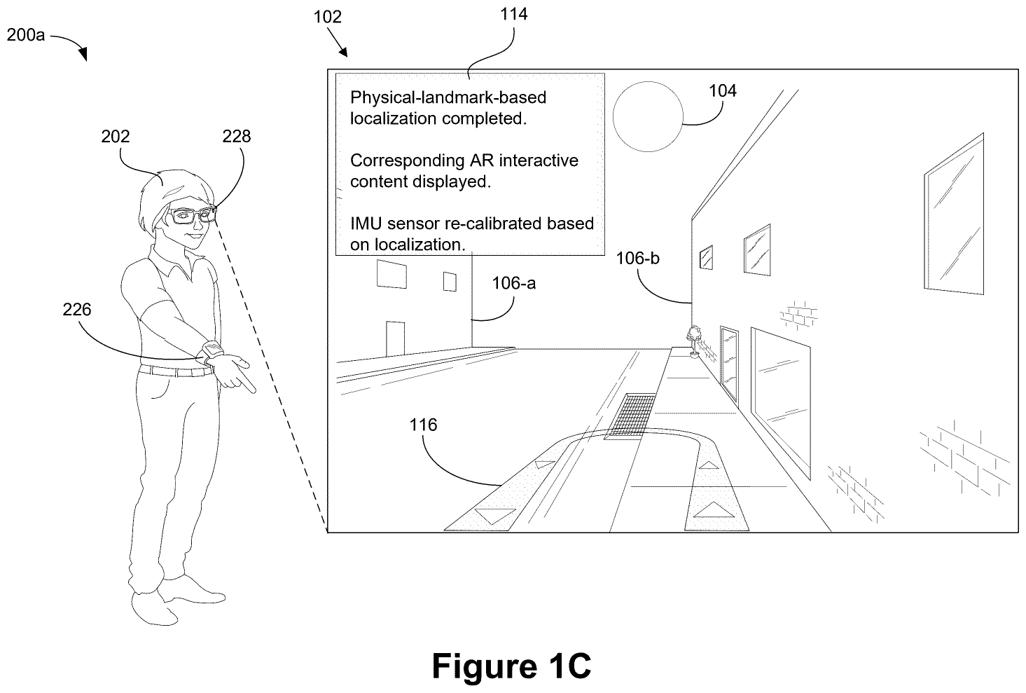

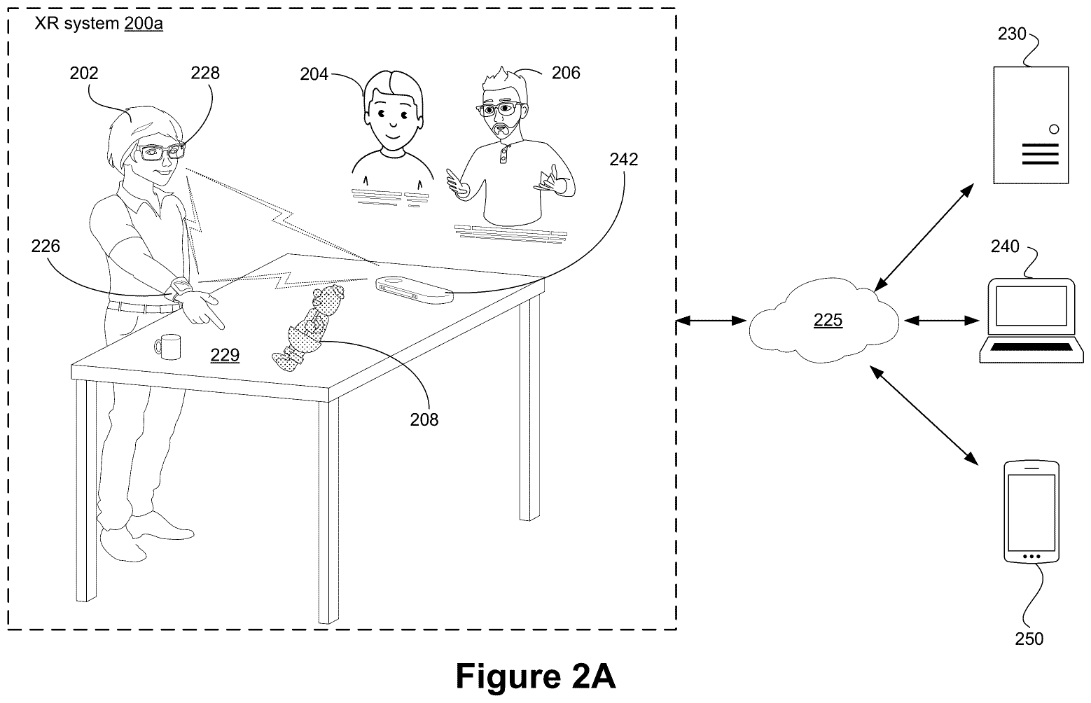

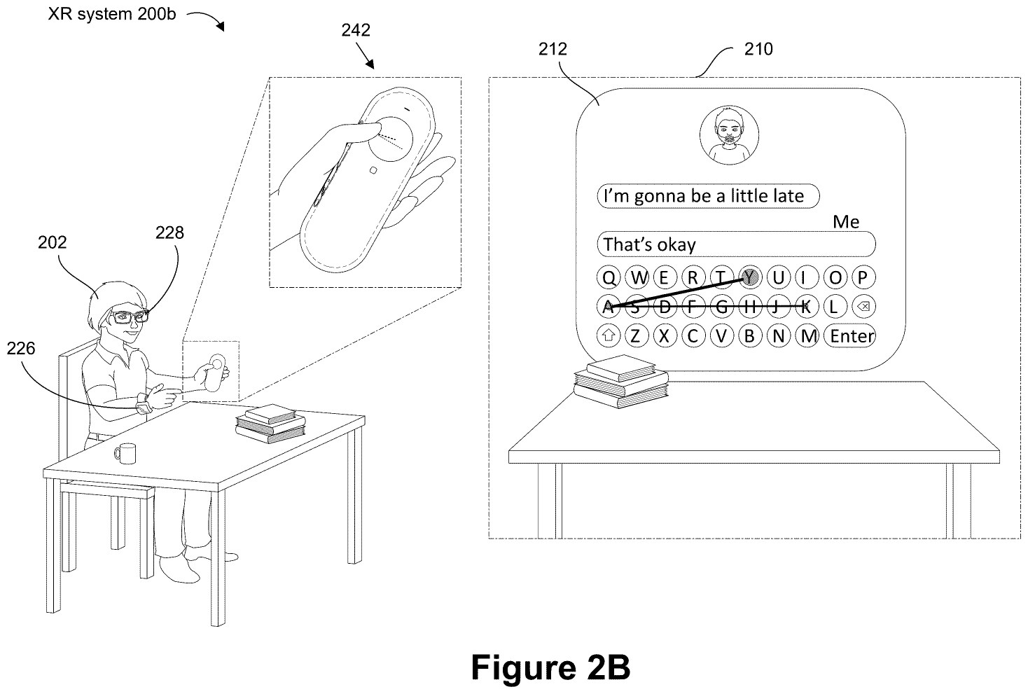

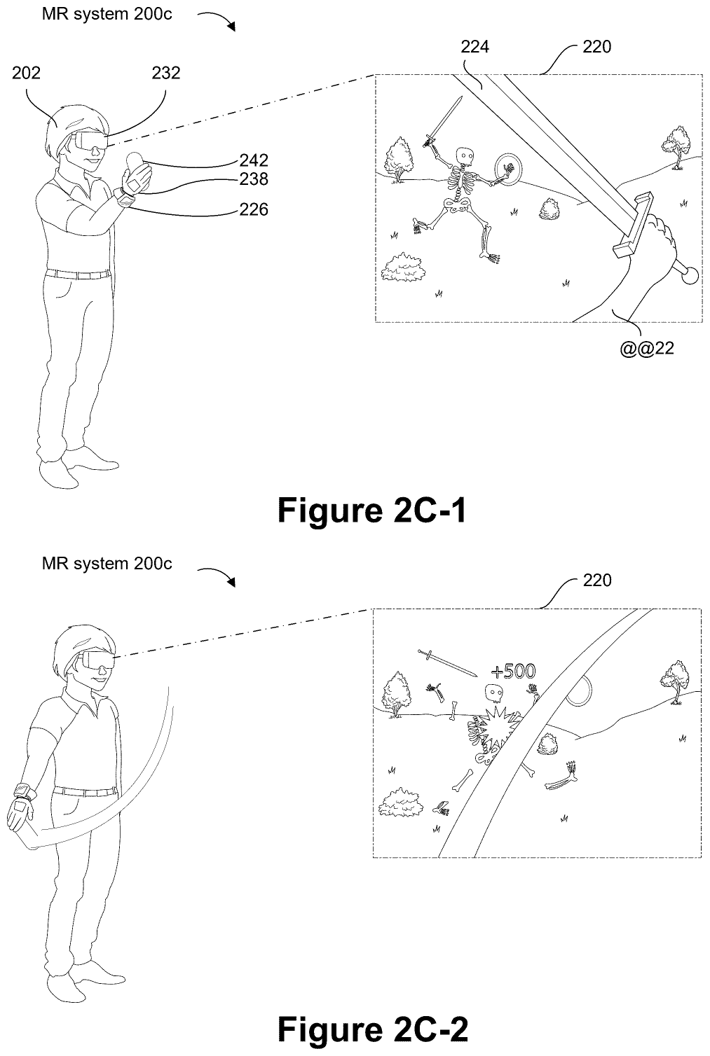

FIGS. 1A to 1C illustrate an example sequence of a user's interaction with an augmented-reality device while the user is interacting with augmented-reality content for causing localized user interactions using physical-landmark-based localization techniques, in accordance with some embodiments. For ease of description, reference will be made to devices, components, and aspects described inf FIGS. 2A to 2C-1, but a skilled artisan will appreciate that the techniques described herein can be implemented with other devices and/or components other than those described herein.

FIG. 1A illustrates a user 202 interacting with an AR system 200a, including an AR device 228 (e.g., an AR glasses device) and a wrist-wearable device 226 (e.g., a smart watch device). As shown by the illustration of the user's field of view 102 on the right side of FIG. 1A, the user is on a city street with buildings and there is a physical landmark (and specifically, a celestial landmark 104 (e.g., a sun or a moon)). In accordance with some embodiments, a notification user interface element 108 is presented, and provides information as to whether a localization condition (e.g., a landmark-based-localization condition) is satisfied for using physical-landmark-based localization techniques to precisely determine a position and orientation of the user 202 within their physical surroundings. For example, the notification user interface element 108 includes a notification indicating that the localization condition is satisfied (stating: “Localization condition satisfied”) as well as information related to why the localization condition is satisfied (e.g., “AR content requires localized positioning”; “celestial landmark available”; and “buildings inhibiting other locating techniques”).

FIG. 1B illustrates another portion of the sequence initiated in FIG. 1A, in which the AR system 200a has begun obtaining sensor data to perform physical-landmark-based positioning based on a physical landmark in the field of view 102 of the physical surroundings of the user 202.

A notification user interface element 110 presents a notification to the user 202 that sensor data is being obtained and instructing the user to direct the AR device 228 towards a particular position within the field of view of the user 202 (e.g., an indicated portion 112), in accordance with some embodiments. In some embodiments, the physical-landmark-based localization includes obtaining information about a location of a physical landmark in the user's surroundings (e.g., the celestial landmark 104). In some embodiments, the

In some embodiments, power is caused to be increased to one or more sensors of the second AR system 200b (e.g., at the wrist-wearable device 226 and/or the AR device 228) based on the determination that the localization condition is satisfied, in order to perform the operations for the physical-landmark-based localization techniques. For example, an infrared imaging sensor may be activated at AR device to identify aspects of the physical landmark, or a resulting effect of the presence of the physical landmark (e.g., a shadow, and/or ground heating or cooling caused by a defined effect of the physical landmark).

In some embodiments, power is caused to be decreased at one or more sensors or other components of the AR system 200a based on the determination that the localization condition is satisfied. For example, in some embodiments, power is reduced to a compass, a GPS component, and/or an IMU device of the AR system 200a based on determining that the physical-landmark-based localization techniques are being performed. That is, the AR system 200a can determine, based on the determining that the localization condition is satisfied, that certain other components of the AR system are not benefiting the system for determining the position and orientation of the user for the purposes required by the AR system 200a to facilitate AR interactions by the user.

FIG. 1C shows another portion of the sequence illustrated by FIGS. 1A and 1B, where a user interface element is presented based on the physical-landmark-based localization performed in accordance with the AR system 200a making the localization determination based on the conditions discussed in more detail in FIG. 1A. For example, a navigational user interface element 116 is presented to appear on the ground in front of the user, where the navigational user interface element 116 provides instruction to the user for navigating within the physical surroundings. And a notification user interface element 114 is presented at the display indicating that the physical-landmark-based positioning was completed, that the corresponding AR interactive content is being displayed, and that IMU calibration was performed as part of performing the physical-landmark-based localization operations.

### Example Extended Reality Systems

FIGS. 2A, 2B, 2C-1, and 2C-2, illustrate example XR systems that include AR and MR systems, in accordance with some embodiments. FIG. 2A shows a first XR system 200a and a first example user interactions using a wrist-wearable device 226, a head-wearable device (e.g., AR device 228), and/or a handheld intermediary processing device (HIPD) 242. FIG. 2B shows a second AR system 200b and second example user interactions using a wrist-wearable device 226, AR device 228, and/or an HIPD 242. FIGS. 2C-1 and 2C-2 show a third MR system 200c and third example user interactions using a wrist-wearable device 226, a head-wearable device (e.g., a mixed-reality device such as a virtual-reality (VR) device), and/or an HIPD 242. As the skilled artisan will appreciate upon reading the descriptions provided herein, the above-example AR and MR systems (described in detail below) can perform various functions and/or operations.

The wrist-wearable device 226, the head-wearable devices, and/or the HIPD 242 can communicatively couple via a network 225 (e.g., cellular, near field, Wi-Fi, personal area network, wireless LAN, etc.). Additionally, the wrist-wearable device 226, the head-wearable devices, and/or the HIPD 242 can also communicatively couple with one or more servers 230, computers 240 (e.g., laptops, computers, etc.), mobile devices 250 (e.g., smartphones, tablets, etc.), and/or other electronic devices via the network 225 (e.g., cellular, near field, Wi-Fi, personal area network, wireless LAN, etc.). Similarly, a smart textile-based garment, when used, can also communicatively couple with the wrist-wearable device 226, the head-wearable device(s), the HIPD 242, the one or more servers 230, the computers 240, the mobile devices 250, and/or other electronic devices via the network 225 to provide inputs.

Turning to FIG. 2A, a user 202 is shown wearing the wrist-wearable device 226 and the AR device 228, and having the HIPD 242 on their desk. The wrist-wearable device 226, the AR device 228, and the HIPD 242 facilitate user interaction with an AR environment. In particular, as shown by the first AR system 100a, the wrist-wearable device 226, the AR device 228, and/or the HIPD 242 cause presentation of one or more avatars 204, digital representations of contacts 206, and virtual objects 208. As discussed below, the user 202 can interact with the one or more avatars 204, digital representations of the contacts 206, and virtual objects 208 via the wrist-wearable device 226, the AR device 228, and/or the HIPD 242. In addition, the user 202 is also able to directly view physical objects in the environment, such as a table 229, through transparent lens(es) and waveguide(s) of the AR device 228. Alternatively, a MR device could be used in place of the AR device 228 and a similar user experience can take place, but the user would not be directly viewing physical objects in the environment, such as table 229, and would instead be presented with a virtual reconstruction of the table 229 produced from one or more sensors of the MR device (e.g., an outward facing camera capable of recording the surrounding environment).

The user 202 can use any one or more of the computing devices described herein, such as the wrist-wearable device 226, the AR device 228 (e.g., through physical inputs at the AR device and/or built in motion tracking of a user's extremities), a smart-textile garment, externally mounted extremity tracking device, the HIPD 242 to provide user inputs, etc. For example, the user 202 can perform one or more hand gestures that are detected by the wrist-wearable device 226 (e.g., using one or more EMG sensors and/or IMUs built into the wrist-wearable device) and/or the AR device 228 (e.g., using one or more image sensors or cameras) to provide a user input. Alternatively, or additionally, the user 202 can provide a user input via one or more touch surfaces of the wrist-wearable device 226, the AR device 228, and/or the HIPD 242, and/or voice commands captured by a microphone of the wrist-wearable device 226, the AR device 228, and/or the HIPD 242. The wrist-wearable device 226, the AR device 228, and/or the HIPD 242 include an artificially intelligent (AI) digital assistant to help the user in providing a user input (e.g., completing a sequence of operations, suggesting different operations or commands, providing reminders, confirming a command). For example, the digital assistant can be invoked through an input occurring at the AR device 228 (e.g., via an input at a temple arm of the AR device 228). In some embodiments, the user 202 can provide a user input via one or more facial gestures and/or facial expressions. For example, cameras of the wrist-wearable device 226, the AR device 228, and/or the HIPD 242 can track the user 202′s eyes for navigating a user interface.

The wrist-wearable device 226, the AR device 228, and/or the HIPD 242 can operate alone or in conjunction with each other to allow the user 202 to interact with the AR environment. In some embodiments, the HIPD 242 is configured to operate as a central hub or control center for the wrist-wearable device 226, the AR device 228, and/or another communicatively coupled device. For example, the user 202 can provide an input to interact with the AR environment at any of the wrist-wearable device 226, the AR device 228, and/or the HIPD 242. In some embodiments, the HIPD 242 can identify one or more back-end and front-end tasks to cause the performance of the requested interaction and distribute instructions to cause the performance of the one or more back-end and front-end tasks at the wrist-wearable device 226, the AR device 228, and/or the HIPD 242. In some embodiments, a back-end task is a background-processing task that is not perceptible by the user (e.g., rendering content, decompression, compression, etc.), and a front-end task is a user-facing task that is perceptible to the user (e.g., presenting information to the user, providing feedback to the user, etc.)). The HIPD 242 can perform the back-end tasks and provide the wrist-wearable device 226 and/or the AR device 228 operational data corresponding to the performed back-end tasks such that the wrist-wearable device 226 and/or the AR device 228 can perform the front-end tasks. In this way, the HIPD 242, which has more computational resources and greater thermal headroom than the wrist-wearable device 226 and/or the AR device 228, performs computationally intensive tasks and reduces the computer resource utilization and/or power usage of the wrist-wearable device 226 and/or the AR device 228.

In the example shown by the first AR system 200a, the HIPD 242 identifies one or more back-end tasks and front-end tasks associated with a user request to initiate an AR video call with one or more other users (represented by the avatar 204 and the digital representation of the contact 206) and distributes instructions to cause the performance of the one or more back-end tasks and front-end tasks. In particular, the HIPD 242 performs back-end tasks for processing and/or rendering image data (and other data) associated with the AR video call and provides operational data associated with the performed back-end tasks to the AR device 228 such that the AR device 228 performs front-end tasks for presenting the AR video call (e.g., presenting the avatar 204 and the digital representation of the contact 206).

In some embodiments, the HIPD 242 can operate as a focal or anchor point for causing the presentation of information. This allows the user 202 to be generally aware of where information is presented. For example, as shown in the first AR system 200a, the avatar 204 and the digital representation of the contact 206 are presented above the HIPD 242. In particular, the HIPD 242 and the AR device 228 operate in conjunction to determine a location for presenting the avatar 204 and the digital representation of the contact 206. In some embodiments, information can be presented within a predetermined distance from the HIPD 242 (e.g., within five meters). For example, as shown in the first AR system 200a, virtual object 208 is presented on the desk some distance from the HIPD 242. Similar to the above example, the HIPD 242 and the AR device 228 can operate in conjunction to determine a location for presenting the virtual object 208. Alternatively, in some embodiments, presentation of information is not bound by the HIPD 242. More specifically, the avatar 204, the digital representation of the contact 206, and the virtual object 208 do not have to be presented within a predetermined distance of the HIPD 242. Although an AR device 228 is described working with an HIPD, a MR headset can be interacted with in the same way as the AR device 228 (e.g., with respect to the HIPD 242).

User inputs provided at the wrist-wearable device 226, the AR device 228, and/or the HIPD 242 are coordinated such that the user can use any device to initiate, continue, and/or complete an operation. For example, the user 202 can provide a user input to the AR device 228 to cause the AR device 228 to present the virtual object 208 and, while the virtual object 208 is presented by the AR device 228, the user 202 can provide one or more hand gestures via the wrist-wearable device 226 to interact and/or manipulate the virtual object 208. While an AR device 228 is described working with a wrist-wearable device 226, a MR headset can be interacted with in the same way as the AR device 228.

### Integration of Artificial Intelligence With XR Systems

FIG. 2A illustrates an interaction in which an artificially intelligent (AI) virtual assistant can assist in requests made by a user 202. The AI virtual assistant can be used to complete open-ended requests made through natural language inputs by a user 202. For example, FIG. 2A the user 202 makes an audible request 244 to summarize the conversation and then share the summarized conversation with others in the meeting. In addition, the AI virtual assistant is configured to use sensors of the extended-reality system (e.g., cameras of an extended-reality headset, microphones, and various other sensors of any of the devices in the system) to provide contextual prompts to the user for initiating tasks. For example, a user may

FIG. 2A also illustrates an example neural network 252 that is used to train an Artificial Intelligence. Uses of Artificial Intelligences are varied and encompass many distinct aspects of the devices and systems described herein. AI capabilities cover a diverse range of applications and deepen interactions between the user 202 and user devices (e.g., the AR device 228, a MR device 232, the HIPD 242, the wrist-wearable device 226, etc.). The AI discussed herein can be derived using many different training models, including but not limited to artificial neural networks (ANNs), deep neural networks (DNN), convolution neural networks (CNN), recurrent neural network (RNN), large language model (LLM), long short-term memory networks, transformer models, decision trees, random forests, support vector machines, k-nearest neighbors, genetic algorithms, Markov models, Bayesian networks, fuzzy logic systems, and deep reinforcement learnings, etc. For devices and systems herein that employ multiple AIs, depending on the task different models can be used. For example, for a natural language AI virtual assistant a LLM can be used and for object detection of a physical environment a DNN can be used instead.

In another example, an AI virtual assistant can include many different AI models and based on the user's request multiple AI models may be employed (concurrently, sequentially or a combination thereof). For example, an LLM based AI can provide instructions for helping a user follow a recipe and the instructions can be based in part on another AI that is derived from an ANN, a DNN, a RNN, etc. that is capable of discerning what part of the recipe the user is on (e.g., object and scene detection).

As artificial intelligence training models evolve, the operations and experiences described herein could potentially be performed with different models other than those listed above, and a person skilled in the art would understand that the list above is non-limiting.

A user 202 can interact with an artificial intelligence through natural language inputs captured by a voice sensor, text inputs, or any other input modality that accepts natural language and/or a corresponding voice sensor module. In another instance, a user can provide an input by tracking an eye gaze of a user 202 via a gaze tracker module. Additionally, the AI can also receive inputs beyond those supplied by a user 202. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data, etc.) captured in response to a user request by various types of sensors and/or their corresponding sensor modules. The sensors data can be retrieved entirely from a single device (e.g., AR device 228) or from multiple devices that are in communication with each other (e.g., a system that includes at least two of: an AR device 228, a MR device 232, the HIPD 242, the wrist-wearable device 226, etc.). The AI can also access additional information (e.g., one or more servers 230, the computers 240, the mobile devices 250, and/or other electronic devices) via a network 225.

A non-limiting list of AI enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI enhanced functions are fully or partially executed on cloud computing platforms communicatively coupled to the user devices (e.g., the AR device 228, a MR device 232, the HIPD 242, the wrist-wearable device 226, etc.) via the one or more networks. The cloud computing platforms provide scalable computing resources, distributed computing, managed AI services, interference acceleration, pre-trained models, application programming interface (APIs), and/or other resources to support comprehensive computations required by the AI enhanced function.

Example outputs stemming from the use of AI can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 228, a MR device 232, the HIPD 242, the wrist-wearable device 226, etc.), storages of the external devices (servers, computers, mobile devices, etc.), and/or storages of the cloud computing platforms.

The AI based outputs can be presented across different modalities (e.g., audio-based, visual-based, haptic-based, and any combination thereof) and across different devices of the XR system described herein. Some visual based outputs can include the displaying of information on XR augments of a XR headset, user interfaces displayed at a wrist-wearable device, laptop device, mobile device, etc. On devices with or without displays (e.g., HIPD 242), haptic feedback can provide information to the user 202. An artificial intelligence can also use the inputs described above to determine the appropriate modality and device(s) to present content to the user (e.g., a user walking on a busy road can be presented with an audio output instead of a visual output to avoid distracting the user 202).

### Example Augmented-Reality Interaction

FIG. 2B shows the user 202 wearing the wrist-wearable device 226 and the AR device 228, and holding the HIPD 242. In the second AR system 200b, the wrist-wearable device 226, the AR device 228, and/or the HIPD 242 are used to receive and/or provide one or more messages to a contact of the user 202. In particular, the wrist-wearable device 226, the AR device 228, and/or the HIPD 242 detect and coordinate one or more user inputs to initiate a messaging application and prepare a response to a received message via the messaging application.

In some embodiments, the user 202 initiates, via a user input, an application on the wrist-wearable device 226, the AR device 228, and/or the HIPD 242 that causes the application to initiate on at least one device. For example, in the second AR system 200b, the user 202 performs a hand gesture associated with a command for initiating a messaging application (represented by messaging user interface 212); the wrist-wearable device 226 detects the hand gesture; and, based on a determination that the user 202 is wearing AR device 228, causes the AR device 228 to present a messaging user interface 212 of the messaging application. The AR device 228 can present the messaging user interface 212 to the user 202 via its display (e.g., as shown by user 202's field of view 210). In some embodiments, the application is initiated and can be run on the device (e.g., the wrist-wearable device 226, the AR device 228, and/or the HIPD 242) that detects the user input to initiate the application, and the device provides another device operational data to cause the presentation of the messaging application. For example, the wrist-wearable device 226 can detect the user input to initiate a messaging application, initiate and run the messaging application, and provide operational data to the AR device 228 and/or the HIPD 242 to cause presentation of the messaging application. Alternatively, the application can be initiated and run at a device other than the device that detected the user input. For example, the wrist-wearable device 226 can detect the hand gesture associated with initiating the messaging application and cause the HIPD 242 to run the messaging application and coordinate the presentation of the messaging application.

Further, the user 202 can provide a user input at the wrist-wearable device 226, the AR device 228, and/or the HIPD 242 to continue and/or complete an operation initiated at another device. For example, after initiating the messaging application via the wrist-wearable device 226 and while the AR device 228 presents the messaging user interface 212, the user 202 can provide an input at the HIPD 242 to prepare a response (e.g., shown by the swipe gesture performed on the HIPD 242). The user 202′s gestures performed on the HIPD 242 can be provided and/or displayed on another device. For example, the user 202′s swipe gestures performed on the 230 are displayed on a virtual keyboard of the messaging user interface 212 displayed by the AR device 228.

In some embodiments, the wrist-wearable device 226, the AR device 228, the HIPD 242, and/or other communicatively coupled devices can present one or more notifications to the user 202 (e.g., concurrently, or in a coordinated fashion based on an interaction context of the user). The notification can be an indication of a new message, an incoming call, an application update, a status update, etc. The user 202 can select the notification via the wrist-wearable device 226, the AR device 228, or the HIPD 242 and cause presentation of an application or operation associated with the notification on at least one device. For example, the user 202 can receive a notification that a message was received at the wrist-wearable device 226, the AR device 228, the HIPD 242, and/or other communicatively coupled device and provide a user input at the wrist-wearable device 226, the AR device 228, and/or the HIPD 242 to review the notification, and the device detecting the user input can cause an application associated with the notification to be initiated and/or presented at the wrist-wearable device 226, the AR device 228, and/or the HIPD 242.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 228 can present to the user 202 game application data and the HIPD 242 can use a controller to provide inputs to the game. Similarly, the user 202 can use the wrist-wearable device 226 to initiate a camera of the AR device 228, and the user can use the wrist-wearable device 226, the AR device 228, and/or the HIPD 242 to manipulate the image capture (e.g., zoom in or out, apply filters, etc.) and capture image data.

While an AR device 228 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with front-facing LED(s) configured to provide a user with information, e.g., a LED around the right-side lens can illuminate to notify the wearer to turn right while directions are being provided or a LED on the left-side can illuminate to notify the wearer to turn left while directions are being provided. In another embodiment, the AR device can include an outward facing projector such that information (e.g., text information, media, etc.) may be displayed on the palm of a user's hand or other suitable surface (e.g., a table, whiteboard, etc.). In yet another embodiment, information may also be provided by locally dimming portions of a lens to emphasize portions of the environment in which the user's attention should be directed. These examples are non-exhaustive and features of one AR device described above can combined with features of another AR device described above. While features and experiences of an AR device have been described generally in the preceding sections, it is understood that the described functionalities and experiences can be applied in an analogous manner to a MR headset, which is described below in the proceeding sections.

### Example Mixed-Reality Interaction

Turning to FIGS. 2C-1 and 2C-2, the user 202 is shown wearing the wrist-wearable device 226 and a MR device 232 (e.g., a device capable of providing either an entirely virtual reality (VR) experience or a mixed reality experience that displays object(s) from a physical environment at a display of the device), and holding the HIPD 242. In the third MR system 200c, the wrist-wearable device 226, the MR device 232, and/or the HIPD 242 are used to interact within an MR environment, such as a VR game or other MR/VR application. While the MR device 232 present a representation of a VR game (e.g., first MR game environment 220) to the user 202, the wrist-wearable device 226, the MR device 232, and/or the HIPD 242 detect and coordinate one or more user inputs to allow the user 202 to interact with the VR game.

In some embodiments, the user 202 can provide a user input via the wrist-wearable device 226, the MR device 232, and/or the HIPD 242 that causes an action in a corresponding MR environment. For example, the user 202 in the third MR system 200c (shown in FIG. 2C-1) raises the HIPD 242 to prepare for a swing in the first MR game environment 220. The MR device 232, responsive to the user 202 raising the HIPD 242, causes the MR representation of the user 222 to perform a similar action (e.g., raise a virtual object, such as a virtual sword 224). In some embodiments, each device uses respective sensor data and/or image data to detect the user input and provide an accurate representation of the user 202's motion. For example, image sensors (e.g., SLAM cameras or other cameras) of the HIPD 242 can be used to detect a position of the 230 relative to the user 202′s body such that the virtual object can be positioned appropriately within the first MR game environment 220; sensor data from the wrist-wearable device 226 can be used to detect a velocity at which the user 202 raises the HIPD 242 such that the MR representation of the user 222 and the virtual sword 224 are synchronized with the user 202's movements; and image sensors of the MR device 232 can be used to represent the user 202's body, boundary conditions, or real-world objects within the first MR game environment 220.

In FIG. 2C-2, the user 202 performs a downward swing while holding the HIPD 242. The user 202's downward swing is detected by the wrist-wearable device 226, the MR device 232, and/or the HIPD 242 and a corresponding action is performed in the first MR game environment 220. In some embodiments, the data captured by each device is used to improve the user's experience within the MR environment. For example, sensor data of the wrist-wearable device 226 can be used to determine a speed and/or force at which the downward swing is performed and image sensors of the HIPD 242 and/or the MR device 232 can be used to determine a location of the swing and how it should be represented in the first MR game environment 220, which, in turn, can be used as inputs for the MR environment (e.g., game mechanics, which can use detected speed, force, locations, and/or aspects of the user 202's actions to classify a user's inputs (e.g., user performs a light strike, hard strike, critical strike, glancing strike, miss) or calculate an output (e.g., amount of damage)).

While the wrist-wearable device 226, the MR device 232, and/or the HIPD 242 are described as detecting user inputs, in some embodiments, user inputs are detected at a single device (with the single device being responsible for distributing signals to the other devices for performing the user input). For example, the HIPD 242 can operate an application for generating the first MR game environment 220 and provide the MR device 232 with corresponding data for causing the presentation of the first MR game environment 220, as well as detect the 202's movements (while holding the HIPD 242) to cause the performance of corresponding actions within the first MR game environment 220. Additionally, or alternatively, in some embodiments, operational data (e.g., sensor data, image data, application data, device data, and/or other data) of one or more devices is provide to a single device (e.g., the HIPD 242) to process the operational data and cause respective devices to perform an action associated with processed operational data.

In some embodiments, the user 202 can wear a wrist-wearable device 226, wear a MR device 232, wear a smart textile-based garments 238 (e.g., wearable haptic gloves), and/or hold an HIPD 242 device. In this embodiment, the wrist-wearable device 226, the MR device 232, and/or the smart textile-based garments 238 are used to interact within an MR environment (e.g., any AR or MR system described above in reference to FIGS. 2A-2B). While the MR device 232 presents a representation of a MR game (e.g., second MR game environment 220) to the user 202, the wrist-wearable device 226, the MR device 232, and/or the smart textile-based garments 238 detect and coordinate one or more user inputs to allow the user 202 to interact with the MR environment.

In some embodiments, the user 202 can provide a user input via the wrist-wearable device 226, a HIPD 242, the MR device 232, and/or the smart textile-based garments 238 that causes an action in a corresponding MR environment. For example, the user 202. In some embodiments, each device uses respective sensor data and/or image data to detect the user input and provide an accurate representation of the user 202's motion. While four different input devices are shown (i.e., a wrist-wearable device 226, a MR device 232, a HIPD 242, and a smart textile-based garment 238) each one of these input devices entirely on their own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 238) sensor fusion can be utilized to ensure inputs are correct. While multiple input devices are described, it is understood other input devices can be used in conjunction or on their own instead, such as but not limited to: external motion tracking cameras, other wearable devices fitted to different parts of a user, apparatuses that allow for a user to experience walking in a MR while remaining substantially stationary in the physical environment, etc.

As described above, the data captured by each device is used to improve the user's experience within the MR environment. Although not shown, the smart textile-based garments 138 can be used in conjunction with an MR device and/or an HIPD 242.

While some experiences are described as occurring on an AR device and other experiences described as occurring on a MR device, one skilled in the art would appreciate that experiences can be ported over from a MR device to an AR device, and vice versa.

Some definitions of devices and components that can be included in some or all of the example devices discussed are defined here for ease of reference. A skilled artisan will appreciate that certain types of the components described may be more suitable for a particular set of devices, and less suitable for a distinct set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and device that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 2A-2C-2 provided above are intended to augment the description provided in reference to FIGS. 1A to 1C. While terms in the following description may not be identical to terms used in the foregoing description, a person having ordinary skill in the art would understand these terms to have the same meaning.

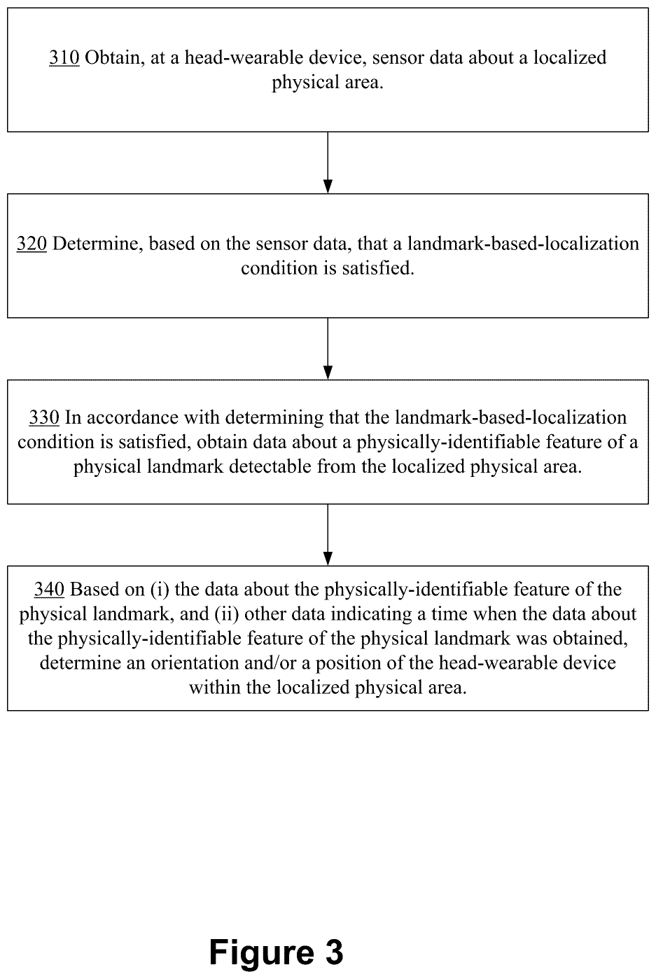

FIG. 3 illustrates a flow chart describing a method 300 of calibrating localization parameters based on physically-identifiable landmarks (e.g., celestial landmarks), in accordance with some embodiments.

(A1) The method 300 includes obtaining (310) at a head-wearable device, sensor data (e.g., imaging data captured by a camera of the head-wearable device, IMU data, time-of-flight data captured by a wrist-wearable device, etc.) about a localized physical area (e.g., an area that is substantially undifferentiated/undifferentiable based on GPS, such as a particular destination on the GPS map, can include a view of objects in other areas such as the sun or a nearby mountain). For example, imaging data may be captured by the AR device 228 to capture information about the physical surroundings of the user 202 (e.g., an indication that there are several large buildings in the user's vicinity).

The method 300 includes determining (320), based on the sensor data, that a landmark-based-localization condition is satisfied. For example, one or more sensors of the AR device 228 in FIG. 1A may be used to determine that the localization condition is satisfied (e.g., based on a level of differentiation of GPS data relative to respective interactions that the user is attempting to perform at the AR system 200a.

The method 300 includes, in accordance with determining that the landmark-based-localization condition is satisfied, obtaining (330) data about a physically-identifiable feature (e.g., visible, thermal, wind, etc.) of a physical landmark detectable from the localized physical area (e.g., a relative location and/or brightness of the sun or moon and/or shadows caused by the respective physical landmark within other parts of the physical area).

The method 300 includes, based on (i) the data about the physically-identifiable feature of the physical landmark, and (ii) other data indicating a time when the data about the physically-identifiable feature of the physical landmark was obtained, determining (340) an orientation and/or and a position of the head-wearable device within the localized physical area (e.g., a precise position of the user within an area that is substantially undifferentiated based on GPS data alone (e.g., a user's position within a phone booth)). For example, notification user interface element 110 in FIG. 1B indicates that the AR device 228 is capturing sensor data and obtaining time-based data to determine the position of the user within the physical area. In some embodiments, the time data is used to determine where the physical landmark should be located based on a current time. In some embodiments, the time data is used to determine where other visual features (e.g., shadows) that are related to the physical landmarks should be located.

(A2) In some embodiments of A1, the method 300 further includes, in accordance with determining the orientation and/or the position of the head-wearable device within the localized physical area, activating one or more components of a speaker of the head-wearable device to cause a directional audio feedback event to be provided to the head-wearable device. For example, based on the respective location and orientation of the user as determined by the physical-landmark-based localization performed in FIG. 1B, directional audio may be provided to the user 202, rather than a visual user interface, to indicate to the user a direction that they should go to continue following navigational instructions.

(A3) In some embodiments of A1 or A2, the method 3 includes, in accordance with determining the orientation and/or the position of the head-wearable device within the localized physical area, presenting one or more artificial-reality content objects based on the orientation and/or the position. For example, FIG. 1C shows a navigational user interface element 116 being presented to the user 202 after the physical-landmark-based localization is performed.

(A4) In some embodiments of any one of A1 to A3, the method further includes, in accordance with determining the orientation and/or the position of the head-wearable device within the localized physical area, re-calibrating one or more sensors of the head-wearable device. For example, the notification user interface element 114 shown in FIG. 1C indicates that, based on performing the physical-landmark-based localization operations in FIG. 1B, an IMU sensor (e.g., of the AR device 128) has been re-calibrated based on data obtained as part of the physical-landmark-based localization operations.

(A5) In some embodiments of A1 to A4, the landmark-based-localization condition is determined based on one or more of: (i) a determination that the head-wearable device is attempting to navigate within an area having a low GPS differentiability (e.g., within a crowded city); (ii) a determination that the head-wearable device is performing an interaction with artificial-reality content presented by the head-wearable device that requires a threshold level of localization precision (e.g., an AR game that includes presenting virtual objects at precise positions within a user's field of view of the localized physical area); (iii) a determination that one or more sensors (e.g., IMU, compass) of the head-wearable device are experiencing inaccuracy that exceeds a threshold error value; and/or (iv) a determination, based on observational data from one or more sensors of the head-wearable device, that the physically-identifiable feature of the physical landmark satisfies a threshold localization value (e.g., determining that the sun is within a current field of view of one or more imaging sensors of the head-wearable device). For example, in FIG. 1A, the notification user interface element 108 presents several reasons to the user why the particular determination was made related to the localization condition (e.g., including that the AR content requires localized position, that a celestial landmark is available, and/or that buildings are inhibiting other locating techniques).

(A6) In some embodiments of any one of A1 to A5, the physical landmark is a celestial body (e.g., a sun, moon, or other celestial landmark) and/or a natural physical effect caused by the celestial body. For example, a location of the celestial landmark 104 to make the physical-landmark-based localization determination in FIGS. 1B and 1C.

(A7) In some embodiments of any one of A1 to A6, the method 300 further includes, in accordance with determining that the landmark-based-localization condition is satisfied, increasing power to one or more imaging sensors of the head-wearable device. For example, one or more camera sensors that had previously been performing a lower frequency polling of the surrounding area may begin actively recording. For example, as described with respect to FIG. 1B, one or more infrared sensors of the AR device 228 may be activated based on the determination to perform the physical-landmark-based localization described with respect to FIGS. 1B and 1C, such that the infrared sensors are able to capture infrared imaging data for determining a position and/or orientation of the user based on the physical landmark.

(A8) In some embodiments of any one of A1 to A7, the method 300 further includes, in accordance with determining that the landmark-based-localization condition is satisfied, decreasing power to one or more sensors of the head-wearable device based the landmark-based-localization condition indicating that the one or more sensors are not functioning properly. For example, the localization condition determined in FIG. 1A may be based on a determination that data being obtained by the IMU of the AR device 228 is inaccurate, and, in response, power may be reduced permanently or temporarily to the IMU while the physical-landmark-based localization is performed.

(A9) In some embodiments of any one of A1 to A8, the sensor data is obtained in accordance with a determination that the head-wearable device is performing a location-based interaction with an interface (visual, audio, etc.) of the head-wearable device. For example, the user may be performing a navigational interaction with at the AR device, including presenting the navigational user interface element 116 shown in FIG. 1C.

(A10) In some embodiments of any one of A1 to A9, the sensor data is obtained from a different device than the head-wearable device. For example, in some embodiments, other devices of the AR system 200a can be used to obtain data (e.g., imaging data) about the celestial landmark 104, which can make it more efficient and/or practical for the user to obtain information about the physical landmark.

(A11) In some embodiments of any one of A1 to A10, the data about the physically-identifiable feature of the physical landmark is a portion of the sensor data used to determine that the landmark-based-localization condition is satisfied. For example, imaging data including the physical landmark may be used to determine that the celestial landmark 104 in FIG. 1A to 1C is positioned such that it can be used reliably for the physical-landmark-based localization operations described herein.

(A12) In some embodiments of any one of A1 to A11, the method 300 further includes, after determining the orientation and/or the position of the head-wearable device within the localized physical area: (i) obtaining other sensor data about a different localized physical area; (ii) in accordance with determining that the landmark-based-localization condition is still satisfied, obtaining additional data about a different physically-identifiable feature of another physical landmark detectable from the different localized physical area; and (iii) based on the additional data, updating the orientation and/or the position of the head-wearable device within the different localized physical area. For example, the user in FIG. 1A may originally be positioned such that the AR device 328 obtains imaging data of a first celestial landmark (e.g., a moon) and then, after walking a distance, may be positioned such that the AR device 328 obtains additional imaging data of a second celestial landmark (e.g., the north star). And based on the triangulation between these two different landmarks, the system may be configured to update a determined orientation and/or position of the AR device 328 based on the result of comparing the positions of the two distinct celestial landmarks. In accordance with some embodiments, the user can provide an input at the AR device 328 indicating which respective celestial landmark is being viewed at a given time.

(A13) In some embodiments of any one of A1 to A12, the method 300 includes, in accordance with determining the orientation and/or the position of the head-wearable device within the localized physical area, comparing the orientation and/or the position determined using the physically-identifiable feature with another localization determination determined without using the physically-identifiable feature. In some embodiments, the method 300 further includes, while a difference between the orientation and/or the position determined using the physically-identifiable feature and the other localization determination exceed a threshold value, persistently determine new respective orientations and/or positions based on the physically-identifiable feature. For example, the user may be within the heart of a big city that is surrounding by large buildings and other obstructions that prevent global positioning data about the user's location from maintaining a high fidelity. In this scenario, once the AR device 328 or another device in electronic communication with the AR device 328 obtain data about the celestial landmark, the system may be configured to continuously monitor the position of the landmark and comparing it to the global positioning data to identify an error amount of the global positioning data. In some embodiments, once the error value of the global positioning data falls below a particular threshold, the system may determine whether to cease tracking the landmark and switch back to using the other data to determine the user's position and/or orientation.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt-in or opt-out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if”' can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A non-transitory computer-readable storage medium comprising instructions that, when executed by one or more processors, cause the one or more processors to:
obtain, at a head-wearable device, sensor data about a localized physical area;
determine, based on the sensor data, that a landmark-based-localization condition is satisfied
in accordance with determining that the landmark-based-localization condition is satisfied, obtain data about a physically-identifiable feature of a physical landmark detectable from the localized physical area; and
based on (i) the data about the physically-identifiable feature of the physical landmark, and (ii) other data indicating a time when the data about the physically-identifiable feature of the physical landmark was obtained, determine an orientation and/or and a position of the head-wearable device within the localized physical area.

2. The non-transitory, computer-readable storage medium of claim 1, the instructions further configured to cause the one or more processors to:
after determining the orientation and/or the position of the head-wearable device within the localized physical area:
obtain other sensor data about a different localized physical area;
in accordance with determining that the landmark-based-localization condition is still satisfied, obtain additional data about a different physically-identifiable feature of another physical landmark detectable from the different localized physical area; and
based on the additional data, update the orientation and/or the position of the head-wearable device within the different localized physical area.

3. The non-transitory, computer-readable storage medium of claim 1, the instructions further configured to cause the one or more processors to:
in accordance with determining the orientation and/or the position of the head-wearable device within the localized physical area:
compare the orientation and/or the position determined using the physically-identifiable feature with another localization determination determined without using the physically-identifiable feature; and
while a difference between the orientation and/or the position determined using the physically-identifiable feature and the other localization determination exceed a threshold value:
persistently determine new respective orientations and/or positions based on the physically-identifiable feature.

4. The non-transitory computer-readable storage medium of claim 1, the instructions further configured to cause the one or more processors to:
in accordance with determining the orientation and/or the position of the head-wearable device within the localized physical area, activate one or more components of a speaker of the head-wearable device to cause a directional audio feedback event to be provided to the head-wearable device.

5. The non-transitory computer-readable storage medium of claim 1, the instructions further configured to cause the one or more processors to:
in accordance with determining the orientation and/or the position of the head-wearable device within the localized physical area, present one or more artificial-reality content objects based on the orientation and/or the position.

6. The non-transitory computer-readable storage medium of claim 1, the instructions further configured to cause the one or more processors to:
in accordance with determining the orientation and/or the position of the head-wearable device within the localized physical area, re-calibrate one or more sensors of the head-wearable device.

7. The non-transitory computer-readable storage medium of claim 1, wherein the landmark-based-localization condition is determined based on one or more of:
a determination that the head-wearable device is attempting to navigate within an area having a low GPS differentiability;
a determination that the head-wearable device is performing an interaction with artificial-reality content presented by the head-wearable device that requires a threshold level of localization precision;
a determination that one or more sensors of the head-wearable device are experiencing inaccuracy that exceeds a threshold error value; and/or
a determination, based on observational data from one or more sensors of the head-wearable device, that the physically-identifiable feature of the physical landmark satisfies a threshold localization value.

8. The non-transitory computer-readable storage medium of claim 1, wherein the physical landmark is a celestial body and/or a natural physical effect caused by the celestial body.

9. A method, comprising:
obtaining, at a head-wearable device, sensor data about a localized physical area;
determining, based on the sensor data, that a landmark-based-localization condition is satisfied
in accordance with determining that the landmark-based-localization condition is satisfied, obtaining data about a physically-identifiable feature of a physical landmark detectable from the localized physical area; and
based on (i) the data about the physically-identifiable feature of the physical landmark, and (ii) other data indicating a time when the data about the physically-identifiable feature of the physical landmark was obtained, determining an orientation and/or and a position of the head-wearable device within the localized physical area.

10. The method of claim 9, further comprising:
after determining the orientation and/or the position of the head-wearable device within the localized physical area:
obtaining other sensor data about a different localized physical area;
in accordance with determining that the landmark-based-localization condition is still satisfied, obtaining additional data about a different physically-identifiable feature of another physical landmark detectable from the different localized physical area; and
based on the additional data, updating the orientation and/or the position of the head-wearable device within the different localized physical area.

11. The method of claim 9, further comprising:
in accordance with determining the orientation and/or the position of the head-wearable device within the localized physical area:
comparing the orientation and/or the position determined using the physically-identifiable feature with another localization determination determined without using the physically-identifiable feature; and
while a difference between the orientation and/or the position determined using the physically-identifiable feature and the other localization determination exceed a threshold value:
persistently determining new respective orientations and/or positions based on the physically-identifiable feature.

12. The method of claim 9, further comprising:
in accordance with determining the orientation and/or the position of the head-wearable device within the localized physical area, activating one or more components of a speaker of the head-wearable device to cause a directional audio feedback event to be provided to the head-wearable device.

13. The method of claim 9, further comprising:
in accordance with determining the orientation and/or the position of the head-wearable device within the localized physical area, presenting one or more artificial-reality content objects based on the orientation and/or the position.

14. The method of claim 9, further comprising:
in accordance with determining the orientation and/or the position of the head-wearable device within the localized physical area, re-calibrating one or more sensors of the head-wearable device.

15. A head-wearable device, comprising one or more processors and memory comprising instructions that, when executed by the one or more processors, cause operations for:
obtaining, at a head-wearable device, sensor data about a localized physical area;
determining, based on the sensor data, that a landmark-based-localization condition is satisfied
in accordance with determining that the landmark-based-localization condition is satisfied, obtaining data about a physically-identifiable feature of a physical landmark detectable from the localized physical area; and
based on (i) the data about the physically-identifiable feature of the physical landmark, and (ii) other data indicating a time when the data about the physically-identifiable feature of the physical landmark was obtained, determining an orientation and/or and a position of the head-wearable device within the localized physical area.

16. The head-wearable device of claim 15, wherein the memory further includes instructions for:
after determining the orientation and/or the position of the head-wearable device within the localized physical area:
obtain other sensor data about a different localized physical area;
in accordance with determining that the landmark-based-localization condition is still satisfied, obtain additional data about a different physically-identifiable feature of another physical landmark detectable from the different localized physical area; and
based on the additional data, update the orientation and/or the position of the head-wearable device within the different localized physical area.

17. The head-wearable device of claim 15, wherein the memory further includes instructions for:
in accordance with determining the orientation and/or the position of the head-wearable device within the localized physical area:
compare the orientation and/or the position determined using the physically-identifiable feature with another localization determination determined without using the physically-identifiable feature; and
while a difference between the orientation and/or the position determined using the physically-identifiable feature and the other localization determination exceed a threshold value:
persistently determine new respective orientations and/or positions based on the physically-identifiable feature.

18. The head-wearable device of claim 15, wherein the memory further includes instructions for:
in accordance with determining the orientation and/or the position of the head-wearable device within the localized physical area, activating one or more components of a speaker of the head-wearable device to cause a directional audio feedback event to be provided to the head-wearable device.

19. The head-wearable device of claim 15, wherein the memory further includes instructions for:
in accordance with determining the orientation and/or the position of the head-wearable device within the localized physical area, presenting one or more artificial-reality content objects based on the orientation and/or the position.

20. The head-wearable device of claim 15, wherein the memory further includes instructions for:
in accordance with determining the orientation and/or the position of the head-wearable device within the localized physical area, re-calibrate one or more sensors of the head-wearable device.
